(19) United States
(12) Patent Application Publication
(10) Pub. No.: US 2025/0353570 A1
(43) Pub. Date: Nov. 20, 2025

(54) BICYCLE WITH REAR SUSPENSION AND RELATIVE DEVICE FOR COMPENSATING CHAIN PULL

(71) Applicant: Ochain S.R.L., Varese (IT)

(72) Inventor: Fabrizio Dragoni, Varese (IT)

(73) Assignee: Ochain S.R.L., Varese (IT)

(21) Appl. No.: 18/870,979

(22) PCT Filed: Jun. 28, 2022
(86) PCT No.: PCT/IT2022/000033

§ 371 Date: Dec. 2, 2024

(51) Int. Cl. B62K 25/28

(52) U.S. Cl. CPC B62K 25/286

(57) ABSTRACT

A bicycle includes a suspension system of the rear wheel, where the crankset and the hub and sprocket each include at least one chainring engaged by the chain and a rotation shaft. A compensation device is interposed between the toothed plate and the shaft to allow an angular compensation stroke between them from a rest position corresponding to the absence of the pulling of the chain, to a compensation position, corresponding to a pulling action of the chain generated by the rear suspension. The compensation device includes a plurality of pairs of brake elements and respective compensation end elements where at least one shock-absorbing element is operationally interposed between at least one pair capable of deforming only in correspondence with a final portion of the compensations stroke and between at least another pair where at least one limiting element is interposed to limit the maximum deformation of the shock-absorbing element.

### DESCRIPTION

The present invention relates to a bicycle with rear suspension and relative device for compensating the travel of said suspension. The invention is particularly suitable for Mountain Bikes, however applications to bicycles with other intended uses or to other sectors are not excluded.

“Full suspended” mountain bikes are known in the bicycle sector, i.e. equipped with rear suspension.

The latter generates a rear wheel travel from the frame with undesirable effects on the transmission, in particular a pull of the chain in the compression phase such as when hit by a jump or impact with asperity. This generates an opposing violent rotation of the pedals in a forward movement which destabilises the rider, making him lose contact with his feet. From a mechanical point of view, the chain is highly stressed and could break. The more this movement is felt and the more damage caused, the greater the displacement of the wheel from the frame.

Please note that the standard of wheel travel depends on the bicycle's category of use. The wheel travel of modern MTB (mountain bike) frames range from a minimum of 80 mm (XC race) to a maximum of 240 mm (downhill race): In between are all other categories.

The problem is particularly felt in the “downhill” categories, i.e. those with rear suspension travels from 130/140 mm upwards. This is not to say that the problem is not felt in the other categories as well. Certainly the indicated travels can be considered a maximum limit that cannot be exceeded with current technology.

The Applicant solved has the problem by introducing a device which allows the rotation between the chainring and the cranks of the crankset to compensate the travel of the shock absorber. This device is described in the international patent application WO2020194177 and can also be applied to the rear wheel hub.

The Applicant has however noted that it may be desirable to improve the effectiveness of peddling resumption and consequently reduce the perception of idle pedalling following the compensation stroke.

Among other things, this would make compensation more acceptable in disciplines with larger rear shock travel.

The general purpose of the presented invention is that of overcoming all or part of the problems of the known technique.

The main objective of the presented invention is to introduce a compensation system which reduces the perception of idle stroke upon the resumption of pedalling.

Another objective is to provide a compensation system which is easy and cheap to implement.

### GENERAL INTRODUCTION

According to the first general aspect, the presented invention relates to a bicycle comprising a frame (5), a rear wheel (10), a suspension system (12) of the rear wheel with respect to the frame allowing a predetermined relative shift between them (H1), a motion transmission system (15) from a crankset (20) to the rear wheel (10), where the transmission system (15) contains a crankset (20) which is fixed to the frame (5), a hub and sprocket (22) fixed to the rear wheel (10) rotatable around their common axis of rotation and a transmission chain (24) directly connecting them to each other, where the crankset (20) and the hub and sprocket (22) contain at least one chainring (26) engaged by said chain and a rotation shaft (44), where a compensation device (240) is operatively interposed between the chainring and the shaft of at least one said crank and said hub and sprocket set to allow an angular compensation stroke (A1) between them from a rest position which corresponds to the absence of the chain pull, to a compensation position, corresponding to a chain pull action generated by said reciprocal displacement, and vice versa, where said compensation stroke is limited to a predetermined angel (A1), said compensation device (40) comprises two main bodies (46, 48) relatively rotatable to each other and integrally respectively to the chairing (26) and the shaft (44), the compensation device (40) also compromises at least one brake element (102) integral with one of the two main bodies (46,48) interposed between a rest end element (104) and a compensation end element (62) integral with the other main body, where the brake element (102) stops alternately against the end elements (104, 62) defining the compensation stroke (A1); characterised in that said compensation device (240) compromises a plurality of pairs of brake elements (102) and respective compensation end elements (62), where at least one shock-absorbing element (39) is operationally interposed between at least one pair able to deform in correspondence with a final section of the compensation stroke alone (A1) and at least one limiting element (38) is interposed between at least another pair as an alternative to the shock-absorbing element (39) which provides a stop to the respective brake element (102) to limit the maximum deformation of the shock-absorbing element (39).

Preferably the shock-absorbing element (39) and the limiting element) have respective G1 and G2 extensions in the direction of travel of the brake element (102) where G1 is greater than G2.

In general, it is preferable that that the limiting element (38) has less deformation capacity than the shock-absorbing element (39).

Preferably the shock-absorbing element (39) compromises at least one elastomeric body and the limiting element compromises at least one metal body.

According preferred embodiments, the limiting element (38) is interchangeable with at least one limiting element (38) of different extensions (G2) in the direction of stroke (A1). This advantageously allows you to adapt to the shock to be absorbed according to the discipline you intend to deal with.

Additionally or alternatively, the shock-absorbing element (39) is interchangeable with at least one shock-absorbing element (39) of different extensions (G2) in the direction of stroke (A1). This also advantageously allows you to adapt to the shock to be absorbed according to the discipline you intend to deal with.

According to some preferred embodiments, the compensation device consists of an adjustment system (100) of said predetermined angle in which at least one of the brake elements (102), the rest end elements (104) and the compensation end elements (62) have an adjustable position relative to the others.

According to a preferable general characteristic, between the two main bodies (46, 48) means of return are operationally interposed towards the rest position where the brake element is at a stop on the rest end element (104) corresponding to the non-firing condition of the chain where the means of recall act for the whole compensation stroke (A1), and the shock-absorbing element (39) has an action that exclusively equates to them at the final end of the compensation stroke (A1).

According to some preferred embodiments, at least one of the two main bodies (46, 48) consists of a Teflon treated sliding surface compared to the other main body.

According to the second general aspect, the invention relates to a kit comprising:

a compensation device (40,240) of the type described in any one of the preceding claims and a plurality of shock-absorbing elements (39) interchangeable with each other and with extensions (G1) in a different direction of stroke (A1) from each other, and/or

a plurality of limiting elements (38) interchangeable with each other and with extensions (G2) in a different direction of stroke (A1) from each other.

According to the third general aspect, the invention relates to a bicycle comprising a frame (5), a rear wheel (10), a suspension system (12) of rear wheel with respect to the frame allowing a predetermined relative shift between them (H1), a motion transmission system (15) from a crankset (20) to the rear wheel (10), where the transmission system (15) contains a crankset (20) fixed to the frame (5) a hub and sprocket (22) fixed to the rear wheel (10) rotatable around their common axis of rotation, and a transmission chain (24) directly connecting them to each other, where the crankset (20) and the hub and sprocket (22) each comprise at least one chainring (26) engaged by said chain and a rotation shaft (44) where between the chainring and the shaft of at least one of said crank and one said hub and sprocket, a compensation device (40) is set to allow an angular compensation stroke (A1) between them from a rest position corresponding to the absence of the chain pull to a compensation position, corresponding to a chain pulling action generated by said reciprocal movement, and vice versa, where said compensation stroke is limited to a predetermined angle (A1), said compensation device (40) comprises two main bodies (46,48) relatively rotatable to each other and integrally respectively to the chainring (26) and the shaft (44), the compensation device (40) also compromises at least one brake element (102) integral with one of the two main bodies (46,48) interposed between a rest end element (104) and a compensation end element (62) integral with the other main body, where the brake element (102) stops alternately against the end elements (104, 62) defining the compensation stroke (A1); characterised in that the two main bodies (46,48) define at least one bearing sliding between them by means of at least one Teflon treated surface and at least one of them destined to slide against the other.

According to the third general aspect, the invention therefore relates to a compensation device (40) of the type indicated above.

According to the fourth general, the present invention relates t and/or hub and sprocket assembly comprised of a compensation device of the type indicated above.

### DETAILED DESCRIPTION

Further characteristics and advantages of the presented invention will become clearer from the following detailed description of its preferred embodiments, made with reference to the attached drawings and given by way of non-limiting examples. In such drawings:

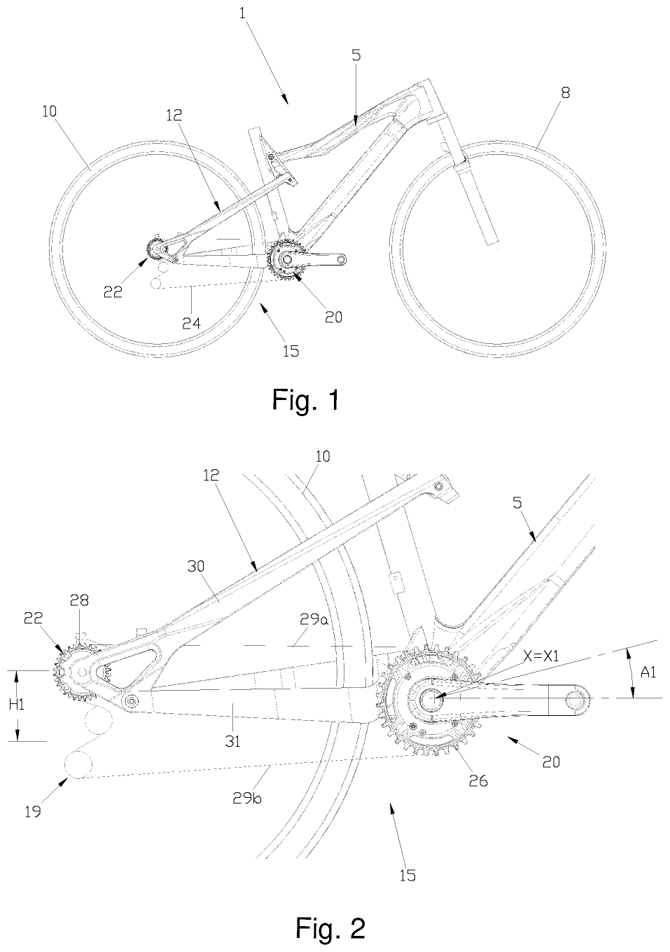

FIG. 1 schematically represents a bicycle according to the presented invention;

FIG. 2 represents the detail of the transmission system of FIG. 1;

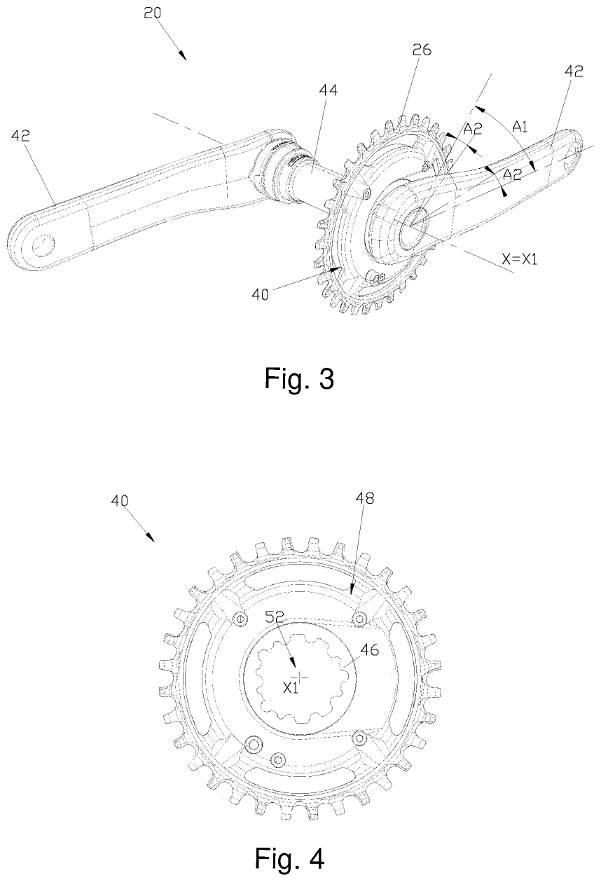

FIG. 3 represents the shaft of the transmission system of FIG. 2;

FIG. 4 represents the compensation device of the shaft of FIG. 3;

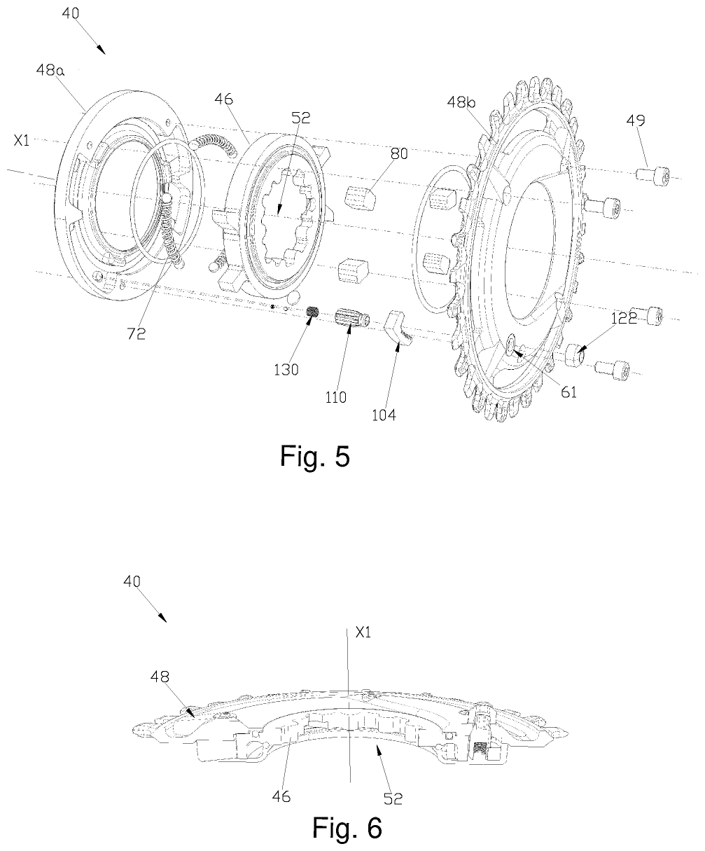

FIGS. 5 and 6 respectively represent an enlarged view and a sectional view of the compensation device of FIG. 4;

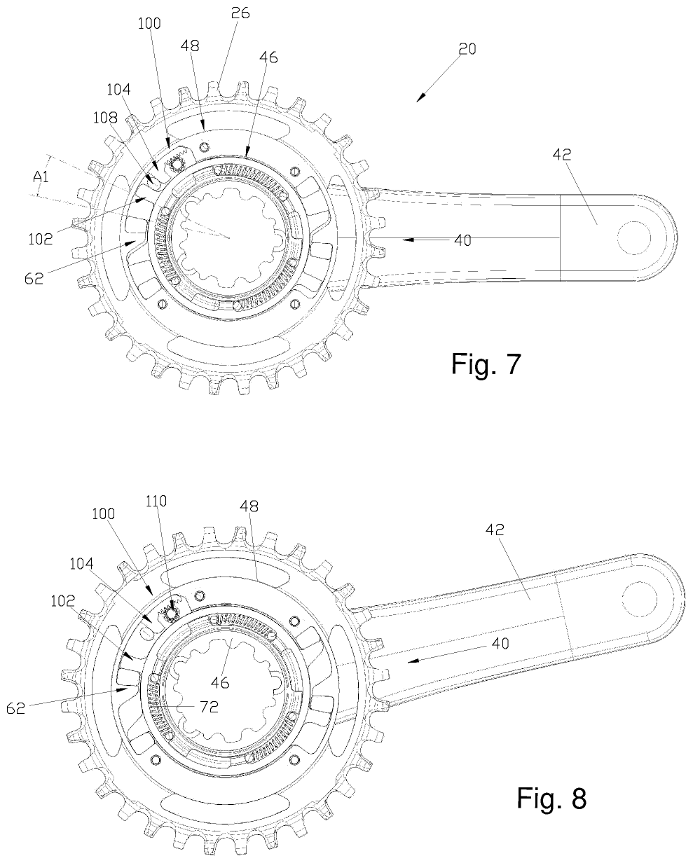

FIGS. 7 and 8 respectively represent the rest position and the opposite position of maximum compensation corresponding to an adjustment which allows a first compensations stroke (A1);

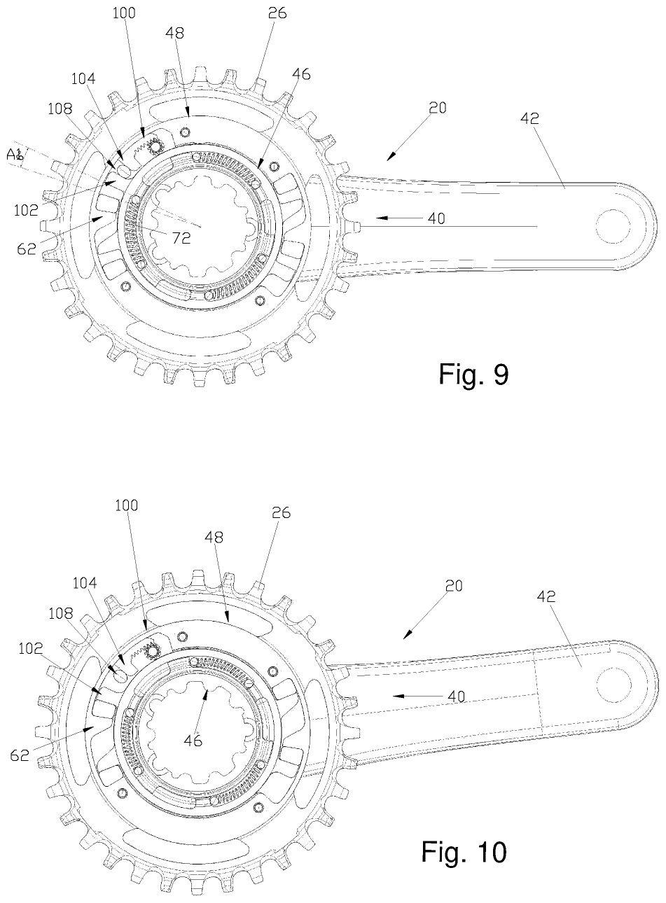

FIGS. 9 and 10 respectively represent the rest position and the opposite position of maximum compensation corresponding to an adjustment which allows a second compensations stroke (A1) greater than that of FIGS. 7 and 8;

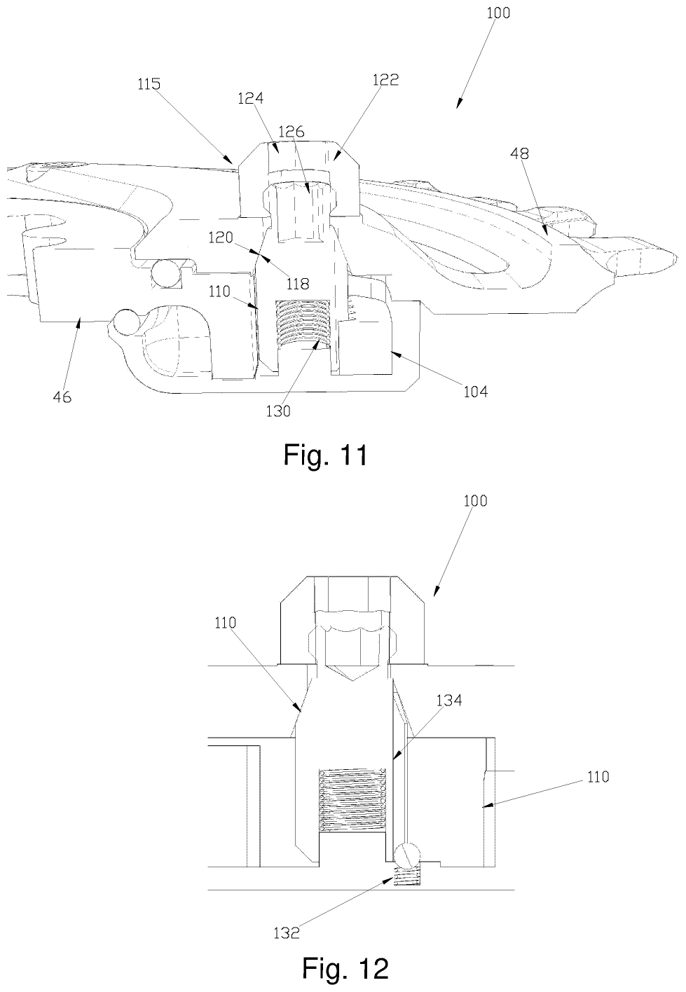

FIG. 11 is a sectional view of the device for adjusting the compensation stroke of the bicycle in the preceding figures;

FIG. 12 shows a variant of FIG. 11 comprising reference means for the adjustment position;

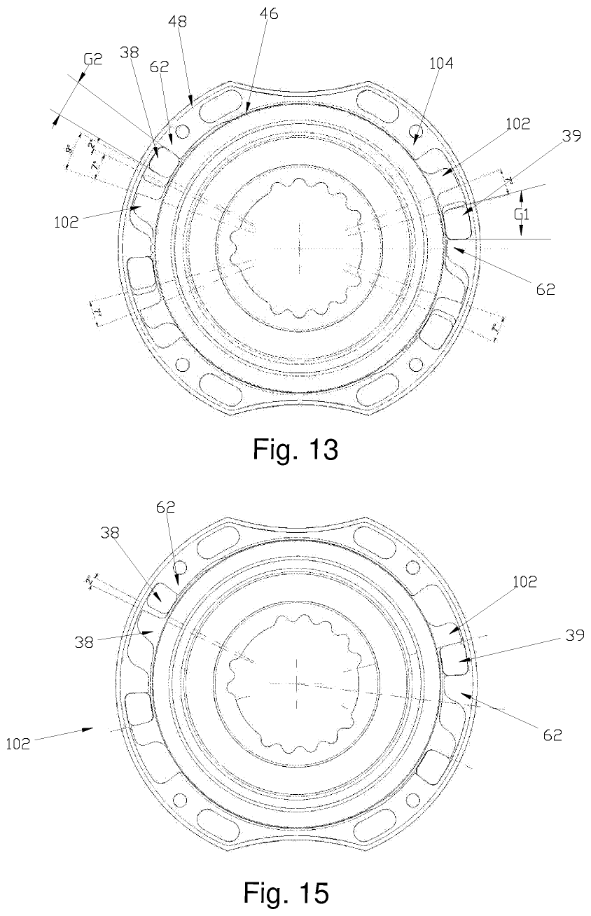

FIGS. 13 to 15 show the positions assumed by an alternative embodiment of the compensation device particularly suitable for reducing the sensation of idle stroke when peddling is resumed.

FIG. 1 shows a bicycle according to the presented invention indicated as a whole with reference number 1.

The bicycle 1 comprising a frame 5, a front wheel 8, a rear wheel 10, a suspension system 12 of the rear wheel 10, a transmission system 15 to rotate the rear wheel 10 by means of a crankset 20 fixed to the frame 5.

The suspension system 12 can be of any applicable type, for example comprised of suspension arms 30,31 articulated to each other and to the frame to allow a predetermined oscillation of the wheel 10 and comprised of means for the shock absorbing of said oscillation (not shown).

In addition to the crankset, the transmission system 15 also comprises a rear hub and sprocket 22 fixed to the wheel 10 and a transmission chain 24 which transmits motion between them.

During use, the oscillation H1 of the rear wheel 10 results in the oscillation of the hub and sprocket 22 respectively to the crankset 20 and consequently a pull of the chain 24.

In particular the crankset 20 and the rear hub and sprocket 22 each comprise at least one chainring 26 and 28 and the chain 24 forms a ring with which is engages them both having two portions 29a and 29b suspended between said wheels. When the rear wheel 10 swings upwards due to a rough surfaces or a jump, the chain is subjected to a pull. The phenomenon is known as “pedal kickback”.

In general, the upper portion of chain 29a is subjected to tension, while the lower portion 29b is slack. This can happen because in general it is preferable that the transmission system comprises a gearbox 19 with an articulated arm of the traditional type comprising rocker arm and cage, oscillating by elastic springs which compensate for the pulling stresses on the lower section 29b of the chain.

In the following we will describe a chain tension compensation device 40 applied to the crankset 20. It is described with reference to the application of the compensation device to the crankset which is applicable specularly to the application of the hub and/or sprockets of the rear wheel.

With reference to FIG. 3, the crankset 20 comprises a pair of pedal cranks 42 coupled to a transmission shaft 44 rotatable around an x-axis, to drive the chainring 26 in rotation.

The compensation device 40 comprises an adjustment system 100 and is operationally interposed between the pedal cranks and the chainring 26.

The compensation device 40 allows a relative rotation Al between the pedal cranks 42 and the chainring 26 of a predetermined amount. The entity of Al is adjustable by the adjustment system 100 as will be clarified below, and determines the amount of oscillation H1 that can be compensated, as well as the amount of free travel of the pedal crank felt during the resumption of pedalling.

The relative rotation Al is also called the compensation stroke and takes place both in outward and in return between two extremes called “limit switches”, in particular there is an end of rest stroke 104 corresponding to the absence of chain pull, and an end of compensation stroke 62 corresponding to the position assumed in the presence of the maximum compensable chain tension.

With reference to FIGS. 4, 5 and 6, the compensation device 40 comprises a first and a second main body 46, 48 coupled to rotate relatively to each other around an axis X1.

The first main body 46 comprises an opening 52 with a shape which is complementary to a shaped profile for the transmission of torque of the shaft 44 (not visible) and such that, in the condition that it is assembled on the crankset 20, the axes of rotation of the shaft and X1 of the compensation device 40 coincide. The first main body 46 is therefore generally integral in rotation to the shaft and to the pedal crank 42.

The second main body 48 is a shell comprising the chainring 26 of a plurality of coupling points 61 to the chainring 26. The wheel (48) is preferably divided into two half-shells (48a and 48b) which can be coupled and decoupled from each other. The first main body 46 is housed inside the second main body 48 in a rotatable manner respectively to the x-axis of the shaft 44. The first body 46 is retained inside the second body 48 which the two half-wheels 48s and 48b are tightened together, for example by screws 49.

With reference to FIGS. 7 and 8, the compensation device 40 is mounted in the crankset 20 with the half-shell 48a which is removed for clarity of description. The crankiest is of the type intended to by mounted on the right side of the bicycle, seen by an observer riding the bicycle and with reference to the direction of travel.

The device 40 generally comprises means for defining the compensation stroke A1 consisting of at least one brake element 102, integral with one of the two main bodies 46 and 48, interposed between a pair of end elements 104 and 62 of the compensation stroke A1, integral to the other main body. The brake element 102 abuts alternatively against the end elements 104 and 62 defining the stroke Al and in general its path is a sector of a circle around the axis of rotation X1 of the bodies 46 and 48. In particular, as shown in FIG. 7, when the brake element 102 abuts the end element 104, the compensation device is in rest position, corresponding to the absence of the chain pull, i.e. when the suspension system is extended and the rear wheel is therefore at its maximum length of travel H1. For this reason, the element 104 is also called the resting end element.

When, as shown in FIG. 8, the brake element 102 abuts against the end element 62, the device 40 is in the position of maximum compensation i.e. in the presence of a chain pull which has caused the main bodies 46 and 48 to rotate respectively to each other by an amount equal to the compensation stroke A1 where the chain pull was generated by the travel of the rear wheel which reduced the length H1 compared to the rest position. For this reason the element 62 is called the compensation end element.

In the particular embodiment of FIGS. 7 to 10, the mentioned adjustment system 100 is present which ensures that at least one of the brake elements 102, the rest end element 104 and the compensation end element 62 have an adjustable position respectively to the others. Preferably at least one of the brake elements 102 and the rest end elements have an adjustable position respectively to the other and even more preferably at least the rest end element 104 (or it alone) has an adjustable position in line with the relative body with which it moves in solidarity.

Between the main bodies 46 and 48 there are generally interposed return means 72 which keep the compensation device 40 in the rest position, whereby they act in opposition to the chain pulling. The return means 72 are for example elastic and preferably contain one or more springs, for example helical springs housed in circumferential places formed between the two main bodies 46 and 48. Said elastic means 72 are compressed by the relative rotation between the main 46 and 48 during stroke Al to go from the rest position to the position of maximum compensation.

In addition, a shock-absorbing element 108 is preferably interposed between the elements 102 and 102 of the adjustment system 100, for example a body made of elastomeric material to cushion their abutment at the respective end of the stroke A1. Said shock-absorbing element is compressed when the device 40 is in the rest configuration. In the rest configuration, the return means 72 and the shock-absorbing element 108 are antagonistic, i.e. the element 108 is compressed in opposition to the return action of the elastic means 72.

FIGS. 7 and 8 show the example respectively of a rest position and a compensation position corresponding to an adjustment of the system 100 set to define a first stroke A1. FIGS. 9 and 10 show the same shaft with the adjustment system 100 set to define a stroke Al which is smaller than that of FIGS. 7 and 8 by moving the end element 104 by a predetermined angular sector in line with the main body 46 to which it is integral in rotation.

In this regard, the adjustment system is shown in greater detail in FIG. 11.

It comprises the rest end element 104 in the form of a rack, moved by a toothed pin 110 carried by the main body 48.

The system 100 comprises a device 115 for locking and unlocking the pin 110 in line with he main body 48 so as to prevent or respectively allow its use for adjusting the compensation stroke A1.

The locking and unlocking system comprises a conical seat 11 for a complementary conical portion 120 of the pin 110 and nut 122 screwed to one of the pin and it abuts against the main body 48 to put the pin in traction and generate the wedging of the cone in its place. When the pin is placed in traction it is locked and vice versa unlocked and can rotate in line with he main body 48 to move the rack 104. The pin and the nut have respective places 124 and 126 for the engagement with a nested tool, where for example the place of the pin is in correspondence with a head in which there is a thread to which the nut 122 is screwed. In general the pin has an actuation interface accessible from the outside of the compensation device, for example it protrudes from one side of the main body 48, in this way it is not necessary to disassemble the device to carry out the adjustment.

The adjustment system 100 also comprises preloading means 130 of the pin 110 which act to push its taper 120 into the taper of the seat 118 which comprise elastic means, for example a spring. The preloading means act when the pin is unlocked to prevent it from moving in line with the set adjustment position due to the return means 72.

In use, the user unscrews the nut 122 to free the pin 110, the rotates the pin 110 to move the rack 104 until the desired compensation stroke A1 is obtained, and locks the pin 110 again by screwing the nut 122.

As better visible in FIG. 12, it is optionally possible to provide reference means for the adjustment, for example comprising a grain 132 pushed by a relative bring to engage the teeth 134 of the pin to provide a sound reference to the amount of rotation imposed during adjustment. In fact the grain will generate a click for each tooth climbed over.

As seen from the comparison of FIGS. 8 and 10, in the compensation position the respective brake element 102 stops against the compensation end 62. This position is not modified by the adjustment system 100, since in the illustrated example it acts only on the position of the rest end 104 and not on the compensation end 62.

As noted, in the general the effect of the adjustment of the compensations stroke A1 by the adjustment system 100 is also that of preloading the return means 72, in the example illustrating the springs 72, so that when pedalling is resumed, there is a minor sensation of free running.

In general, we also observe that the return means are shock-absorbing means 72 of the angular compensation stroke A1, operatively interposed between the first and second main bodies 46 and 48 and act for the entire compensation stroke A1 towards the compensation position, in any system adjustment position 100.

As previously said, the shock-absorbing elements 108 instead generally represent shock-absorbing means antagonistic of the previous ones, which are only active in a predetermined angular section of the limit switch A1 in correspondence with the rest position.

When used downhill and/or in a jump, the rider places himself on the pedals with the cranks 42 arranged horizontally (position of maximum stability). In this position, the compensation device is in the rest condition of FIG. 7 or 9 due to the trust of the means of return 72. When the e rear wheel rises, due to an impact, it generates the chain pull which rotates the chainring 26 in line with the pedal cranks 52 for the compensation stroke portion A1, placing the compensation device 40 in the condition of maximum stroke seen in FIG. 8 or 10, or in an intermediate condition, depending on the stress undergone. This race is considered the outward race.

When the rider resumes pedalling from the rest position of FIG. 7 or 9, the compensation device 40 undergoes the same forward stroke rotation A1 up to the maximum stroke position of FIG. 8 or 10.

The more the maximum possible compensation stroke A1 is shortened by means of the adjustment system reaching, for example, a position as in FIGS. 7 and 8, the more the resumption of pedalling is fluid and immediate due to the greater preload of the means of return 72, to the detriment however, of a lower compensation of the chain pull, which may not be to its full potential in the largest jumps. Vice versa, the greater the maximum possible A1 compensation stroke, as in FIG. 9 or 10, the greater the amount of travel that the rear wheel can make without generating a chain pull, but with a less progressive pedalling restart, due to the lower preload of the means of return 72.

It is observed that, in the preferred example in which the maximum compensation stroke A1 is adjusted by modifying only the position of the rest end 104, the system is more robust and stable, since the adjustment system 100 must not oppose the resulting stresses from the reception from the jumps, but only those of the means of return 72 in returning to the rest position, preferably mitigated by the shock-absorbing elements 108.

In general, the adjustment of the position of the rest end element 104 in line with the main body 48 has been described, however skilled cyclists will be able to make the necessary modifications for applications in which, in addition or alternatively, the adjustable element is the compensation end element 62 or the brake element 102.

A further embodiment of the invention is described below, where elements identical or similar to the previous ones are indicted with the same reference numbers or with the same numbers increased by 200.

With reference to FIGS. 12 to 15, a compensation device according to the presented invention described, is indicated as a whole with the number 240 and comprises a set of characteristics compatible with both the presence of the adjustment system 100 and with its absence. For this reason, by way of example, the embodiment described below has both the rest end 104 and the compensation end 62 fixed (therefore not adjustable) in line with the respective main bodies 46 and 48.

The reason for the compatibility is given by the fact that embodiment focuses on functional this characteristics applicable at the compensation end 62, so that it leaves the freedom to adopt or not the adjustment of the rest end 104.

It can be observed that FIGS. 13 to 15 show the compensation device seen from the opposite side compared to FIGS. 7 to 10, which explains why the elements of FIGS. 13 to 15 are in mirror positions compared to FIGS. 7 to 10.

The means of return 72 are present as in the embodiment of FIGS. 7 to 10, but they are not visible due to the different section and observation point.

Everything is clear when it is considered that FIGS. 13, 14 and 15 show a sequence of approaching the brake element 102 to the compensation end 62, which occurs when pedalling is resumed starting from the rest position. Between the brake element 102 and the compensation end 62 there is an operationally interposed shock-absorbing element 39, for example an elastomeric body with a predetermined extension G1 in the direction of the trajectory of the stop element 102.

FIG. 13 shoes an intermediate stroke position in which the stop element 102 has not yet reached the elastomeric body 39, while FIG. 14 shoes a position in which the brake element 102 and the elastomeric body 39 are in abutment with each other.

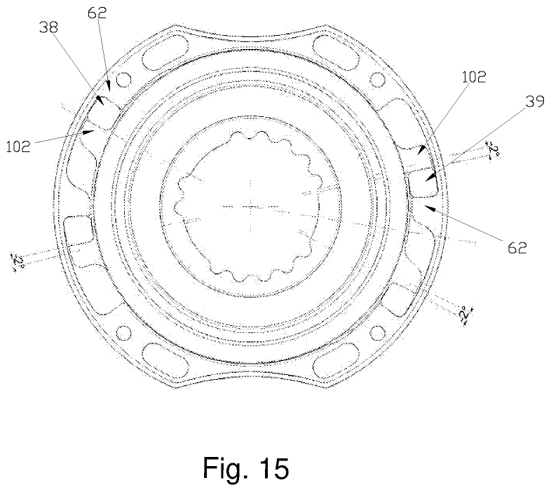

Continuing the stroke, the brake element 102 compresses the elastomeric body 39 however between the main bodies 46 and 48 a limiting element of the compressions 38 is interposed and is made of less compressible material than the body of 39, being for example metallic such as an aluminium alloy. The compression of the body 39 consequently maximally reaches the position of FIG. 15.

This can be achieved for example by providing a plurality of pairs of brake elements 102 and compensation end elements 62, where an elastomeric body 39 is interposed between at least one of said pairs and a limiting element 38 is interposed between at least another pair in replacement of the elastomeric body 38, which has an extension G2 in the direction of the stroke of the brake element 102 which is smaller than the extension G1.

Naturally, the elastomeric body 39 and the limiting element 38 are functional elements, so each of them is provided both in a single piece and divided into several pieces, possibly not even joined together but simply side by side.

The elastomeric element 39 and preferably also the limiting element 38 has a ring-like extension around the axis X1.

In use, before starting the pedal stroke, the compensation device 240 is in a rest configuration in which the means of return 72 keep at least one brake element 102 in abutment against at least one rest end 104. When pedalling is started, a resistance is initially felt given by the means of return, which provides an initial reduction of the sensation of empty pedalling. By overcoming this resistance, the compensation device 240 carries out the compensation stroke until at least one brake element 102 is pressed against at least one corresponding elastomeric element 39 as a result of pedalling. By continuing to pedal, the felt resistance increases since the deformation by compression of the elastomeric element 39 is added to the effect of the means of return 72. The deformation continues until another brake element 102 comes into contact with the limiting element 38 which determines the limit switch.

In this way, advantageously, there is a clear sensation of torque transmission already during the deformation of the elastomeric element 39, therefore before having completed the entire compensation stroke A1. The figure shows a stroke in which the deformation of the elastomer is limited to 2 by the limiting element, on a total compensation stroke A1 equal to 9, so that the limited stroke interval in which the deformation takes place is generally less than or equal to 30% of the total stroke A1.

A further advantage is that during a prolonged pedal stroke, the elastomeric elements 39 undergo less stress, so that they have a longer duration.

Another further advantage is the fact that, when the adjustment pf the position of the rest end is also present, the sensation of idle pedalling is considerably attenuated even in the case of setting for the longer A1 strokes.

Advantageously, the limiting element 38 is interchangeable with limiting elements 38 of different extension G2 kit parts, so as to allow the correct compromise of use between compensation of the travel of the bicycle shock absorber and resumption of pedalling.

It is generally observed that in order to contain the overall dimensions of the compensation device 40, 240 in that of an ordinary shaft, it is possible to reduce the sliding friction between the main bodies 46 and 48 by making a sliding bearing between them. This is possible for example by providing at least one sliding surface on at least one of the two main bodies respectively to the other, where said surface is coated by means of a Teflon coating process.

Teflon coating, for example, is made with the following procedure:
apply a natural anodising treatment with open pores to the surface to be tefloned.

apply a Teflon spray treatment to said surface within 24 hours of the anodisation treatment.

This Teflon treatment provides for the deposition of the Teflon-based particles between the irregularities of the surface texture on the surface to be treated, that is, between the “crests and probity” of the material, so that it can continue to provide partial lubrication even after the initial wear, due to wear of the layer and surfaces, has uncovered the “ridges”.

The Teflon-coating process is an aspect applicable to the compensation device both in association with and independently of the aspect of the stroke adjustment and the aspect of the limiting elements (38) to facilitate the resumption of pedalling.

### GENERAL INTERPRETATION OF TERMS

In understanding the scope of the presented invention, the term “comprising” and its derivatives, as used herein, are intended as open-ended terms that specify the presence of the claimed characteristics, elements, components, groups, integers and/or phases, but they do not exclude the presence of other undeclared characteristics, elements, components, groups, integers and/or phases.

The above also applies to the words that have similar meanings such as the terms “including”, “having” and their derivatives. Furthermore, the terms “part”, “section”, “portion”, “member”, or “element”, when used in the singular can have the dual meaning of a single part or of a plurality of parts. As used herein to describe the form(s) above, the following directional terms “forward”, “backward”, “above”, “down”, “vertical”, “horizontal”, “below” and “transverse” as well as any other similar directional terms refers to the embodiment described in operative position. Finally, degree terms such as “substantially”, “about”, and “approximately” as used herein mean a reasonable amount of deviation of the modified term such that the final result is not significantly changed.

While only selected embodiments have been chosen to illustrate the presented invention, it will be apparent to those skilled in the art from this disclosure that various modifications and variations can be made without departing from the scope of the invention as defined in the appended claims. For example, the size, shape, position or orientation of the various components can be changed as needed and/or desired. The components shown directly connected or in contact with each other can have intermediate structures arranged between them. The functions of one element can be performed by two and vice versa. The structures and functions of one embodiment may be adopted in another embodiment. It is not necessary for all the advantages to be present in a particular embodiment at the same time. Any feature that is original compared to the prior art, alone or in other should also be combination with features, considered a separate description of further inventions by the applicant, including the structural and/or functional concepts embodied by those features. Therefore, the foregoing descriptions of the embodiments according to the presented invention are provided for illustrative purposes only and not for the purpose of limiting the invention as defined by the appended claims and their equivalents.

1. Bicycle comprising a frame, a rear wheel, a suspension system of the rear wheel with respect to the frame allowing a predetermined relative shift between them, a motion transmission system from a crankset to the rear wheel,
wherein the transmission system comprises a crankset which is fixed to the frame, a hub and sprocket fixed to the rear wheel and a transmission chain directly connecting them to each other,
wherein the crankset and the hub and sprocket are subject to reciprocal displacement due to the action of the suspension,
wherein the crankset and the hub and sprocket each contain at least one chainring engaged by said chain and a rotation shaft,
wherein a compensation device is operatively interposed between the chainring and the shaft of at least one said crank and said hub and sprocket and is set to allow an angular compensation stroke between them from a rest position which corresponds to the absence of the chain pull, to a compensation position, corresponding to a chain pull action generated by said reciprocal displacement, and vice versa,
wherein said compensation stroke is limited to a predetermined angel, said compensation device comprises two main bodies relatively rotatable to each other and integrally rotatable to the chainring and the shaft, the compensation device also compromises at least one brake element integral with one of the two main bodies interposed between a rest end element and a compensation end element integral with the other main body,
wherein the brake element stops alternately against the end elements defining the compensation stroke;
wherein said compensation device (240) compromises a plurality of pairs of brake elements and respective compensation end elements, where at least one shock-absorbing element is operationally interposed between at least one pair able to deform in correspondence with a final section of the compensation stroke alone and at least one limiting element is interposed between at least another pair as an alternative to the shock absorbing element which provides a stop to the respective brake element to limit the maximum deformation of the shock-absorbing element.

2. Bicycle according to claim 1, wherein the shock-absorbing element and the limiting element have respective G1 and G2 extensions in the direction of stroke of the brake element where G1 is greater than G2.

3. Bicycle according to claim 1, wherein the limiting element has less deformation capacity than the shock-absorbing element.

4. Bicycle according to claim 2, wherein the shock-absorbing element compromises at least one elastomeric body and the limiting element compromises at least one metal body.

5. Bicycle according to claim 1, wherein the limiting element is interchangeable with at least a limiting element of different extensions in the direction of stroke.

6. Bicycle according to claim 1, wherein the shock absorbing element is interchangeable with at least one shock-absorbing element of different extensions in the direction of stroke.

7. Bicycle according to claim 1, further comprising an adjustment system of said predetermined angle in which at least one of the brake elements, the rest end elements and the compensating end element have an adjustable position relative to the others.

8. Bicycle according to claim 1, wherein between the two main bodies, means of return are operationally interposed towards the rest position where the brake element is at a stop on the rest end element corresponding to the non-firing condition of the chain where the means of recall act for the whole compensation stroke, and the shock-absorbing element has an action that exclusively equates to them at the final end of the compensation stroke.

9. Bicycle according to claim 1, wherein at least one of the two main bodies includes a Teflon treated sliding surface compared to the other main body.

10. Kit including:
a compensation device of the type described in claim 1 and a plurality of shock-absorbing elements interchangeable with each other and with extensions in a different direction of stroke from each other, and/or a plurality of limiting elements interchangeable with each other and with extensions in a different direction of stroke from each other.
